(19) United States
(12) Patent Application Publication
(10) Pub. No.: US 2016/0145108 A1
(43) Pub. Date: May 26, 2016

(54) METHOD FOR MANUFACTURING GRAPHENE PLATELETS

(71) Applicant: Taiwan Carbon Nanotube Technology Corporation, Miaoli County (TW)

(72) Inventors: Yu-Hong Lin, Miaoli County (TW); Chun-Hsien Tsai, Miaoli County (TW); Ting-Chuan Lee, Miaoli County (TW); Chun-Jung Tsai, Miaoli County (TW)

(21) Appl. No.: 14/623,907

(22) Filed: Feb. 17, 2015

(30) Foreign Application Priority Data
Nov. 24, 2014 (TW) 103140604

(51) Int. Cl. C01B 31/04

(52) U.S. Cl. CPC C01B 31/0469; C01B 2204/32

(57) ABSTRACT

A method for manufacturing graphene platelets includes the following steps of: providing a plurality of graphite blocks each including a plurality of stacked graphene layers, between every two graphene layers being a bonding formed by a van der Waals force; applying a shear airflow produced by an airflow interface formed between a first flow path and a second flow path by a forward airflow and reverse airflow to the graphite block, the shear airflow having an energy sufficient for damaging the van der Waals force to disengage a part of the graphene layers; and collecting a plurality of pieces of the graphene platelets, the graphene platelets including one or multiple of the graphene layers. Thus, the shear airflow of the present invention disengages the graphene layers from the graphite block to form the graphene platelets, thereby providing a simple manufacturing process and promoting mass production at a fast speed.

### FIELD OF THE INVENTION

The present invention relates to method for manufacturing graphene platelets, and particularly to a method for manufacturing graphene platelets by an airflow.

### BACKGROUND OF THE INVENTION

Graphene is an allotrope of carbon, and is a two-dimensional material formed by carbon atoms in a hexagonal honeycomb lattice arrangement. From perspectives of materials, as the graphene features characteristics of being transparent and having high electric conductivity, high heat conductivity, a high strength-to-weight ratio and good ductility, graphene has good development potentials.

The U.S. patent publication No. 2010/0237296 discloses a conventional method for manufacturing graphene, “Reduction of Graphene Oxide to Graphene in High Boiling Point Solvents”. A single graphene oxide sheet is dispersed into water to achieve a dispersion, and a solvent is added to the dispersion to form a solution. The solvent may be N-methlypyrrolidone, ethylene glycol, glycerin, dimethlypyrrolidone, acetone, tetrahydrofuran, acetonitrile, dimethylformamide, amine or alcolhol. The solution is then heated to about 200° C. and purified to obtain a single graphene sheet. Further, the U.S. patent publication No. 2010/0323113 discloses a method to synthesize graphene. In the above disclosure, a hydrocarbon is kept at a high temperature of 40° C. to 1000° C., and carbon atoms are implanted into a substrate. The substrate may be made of a metal or an alloy. As the temperature lowers, the carbon becomes deposited to diffuse out of the substrate to form a graphene layer.

The above methods for manufacturing graphene not only have complicated processes but also slow manufacturing speeds, such that the throughput cannot be effectively increased. Therefore, there is a need for a solution that improves such issues.

### SUMMARY OF THE INVENTION

A primary object of the present invention is to solve issues of complicated processes, slow manufacturing speeds and inefficient throughput of conventional methods for manufacturing graphene platelets.

To achieve the object, the present invention provides a method for manufacturing graphene. The method includes following steps.

In step 1, a plurality of graphite blocks are provided. Each of the graphite blocks include a plurality of stacked graphene layers. A bonding is formed between every two graphene layers by a van der Waals force.

In step 2, the graphite block is placed in a chamber, which is introducing a forward airflow and a reverse airflow into the chamber. The forward airflow forms a first flow path in the chamber, and the reverse airflow forms a second airflow in the chamber. An airflow interface is formed between the forward airflow and the reverse airflow.

In step S3, a shear airflow produced by the airflow interface is applied to the graphite blocks. The shear airflow has an energy sufficient for damaging the van der Waals force such that a part of the graphene layers becomes disengaged.

In step 4, a plurality of pieces of graphene platelets disengaged from the graphite blocks are collected. The graphene platelets include one or multiple of the graphene layers.

As such, in the present invention, the shear airflow produced by the airflow interface is applied to the graphite blocks, such that the graphene layers become disengaged from the graphite blocks to form the graphene platelets. Thus, the present invention provides a simple manufacturing process and further promotes mass production at a fast speed.

### BRIEF DESCRIPTION OF THE DRAWINGS

FIG. 1 is a schematic diagram of steps according to an embodiment of the present invention.

FIG. 2 is a schematic diagram of using an airflow generating device according to an embodiment of the present invention.

FIG. 3A is a first schematic diagram of a shear airflow according to an embodiment of the present invention.

FIG. 3B is a second schematic diagram of a shear airflow according to an embodiment of the present invention.

### DETAILED DESCRIPTION OF THE PREFERRED EMBODIMENTS

The foregoing, as well as additional objects, features and advantages of the invention will be more readily apparent from the following detailed description, which proceeds with reference to the accompanying drawings.

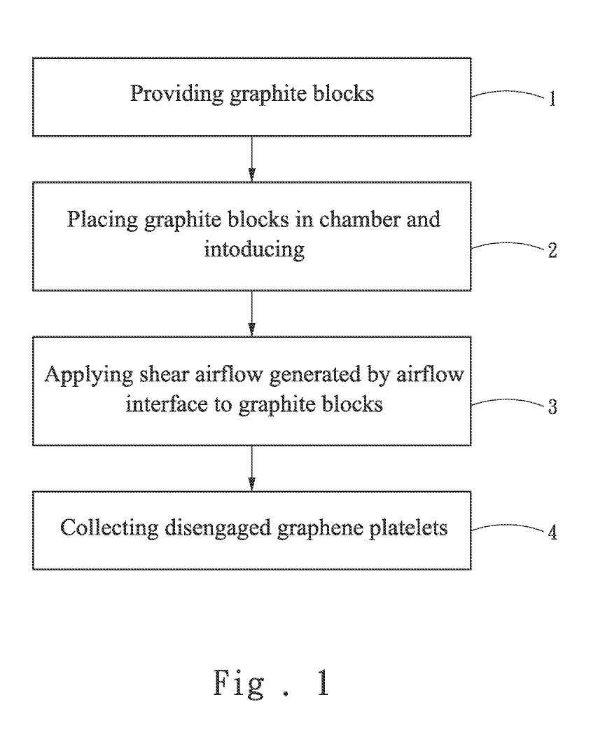

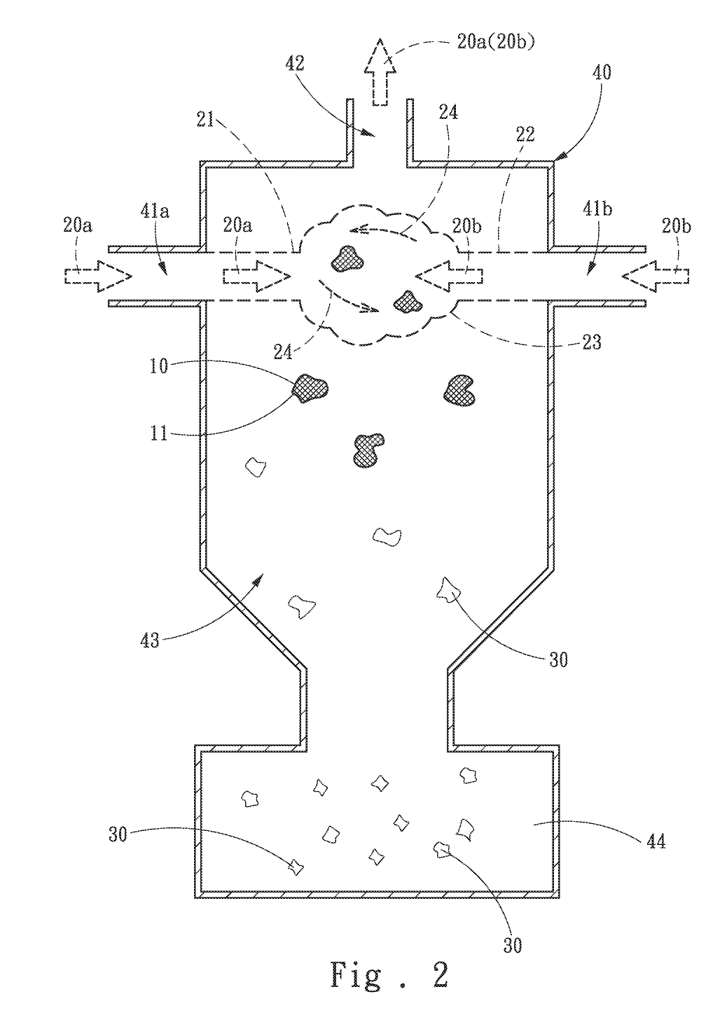

FIG. 1 shows a schematic diagram of steps according to an embodiment of the present invention. FIG. 2 shows a schematic diagram according to an embodiment of the present invention. Referring to FIG. 1 and FIG. 2, a method for manufacturing graphene platelets of the present invention includes following steps.

In step S1, a plurality of graphite blocks 10 are provided. The graphite blocks 10 are formed by graphene. Graphene is an allotrope of carbon. Structurally, each carbon atom is linked to three other surrounding carbon atoms to display a honeycomb arrangement having multiple hexagons. In the embodiment, the size of the graphite blocks 10 may grains or blocks having a length, a width and a height ranging between 10 nm and 1000 μm. Each of the graphite blocks 10 includes a plurality of stacked graphene layers 11. A van der Waals force forms a bonding between every two graphene layers 11.

In step 2, the graphite blocks 10 are placed in a chamber 43, which is introducing a forward airflow 20a and a reverse airflow 20b into the chamber 43. The forward airflow 20a forms a first flow path 21 in the chamber 43, and the reverse airflow 20b forms a second flow path 22 in the chamber 43. An airflow interface 23 is formed between the first flow path 21 and the second flow path 22. In the embodiment, a configuration of the chamber 43 is illustrated by taking an airflow generating device 40 as an example. The airflow generating device 40 includes a first entrance 41a, a second entrance 41b, an airflow exit 42 and the chamber 43. The first entrance 41a receives the forward airflow 20a into the chamber 43 and is in communication with the chamber 43. The second entrance 41b receives the reverse airflow 20b into the chamber 43 and is in communication with the chamber 43. The airflow exit 42 is in communication with the chamber 43. After entering the chamber 43 via the first entrance 41a and the second entrance 41b, respectively, the forward airflow 20a and the reverse airflow 20b form the first flow path 21 and the second flow path 22 in the chamber, respectively. Further, the airflow interface 23 is formed between the first flow path 21 and the second flow path 22. The forward airflow 20a and the reverse airflow 20b may be gases such as air, dry air, nitrogen (N₂), argon (Ar), helium (He), hydrogen (H₂), oxygen (O₂) and ammonia (NH₃). The gases used by the forward airflow 20a and the reverse airflow 20b may be the same or different.

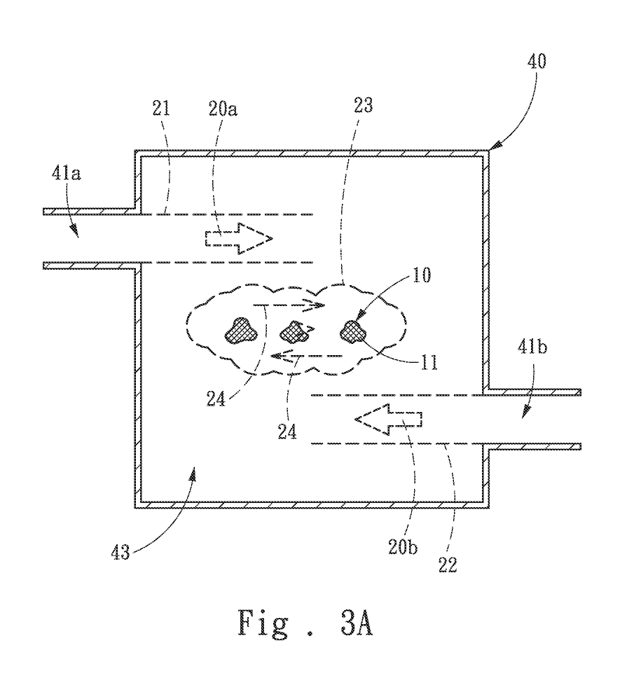

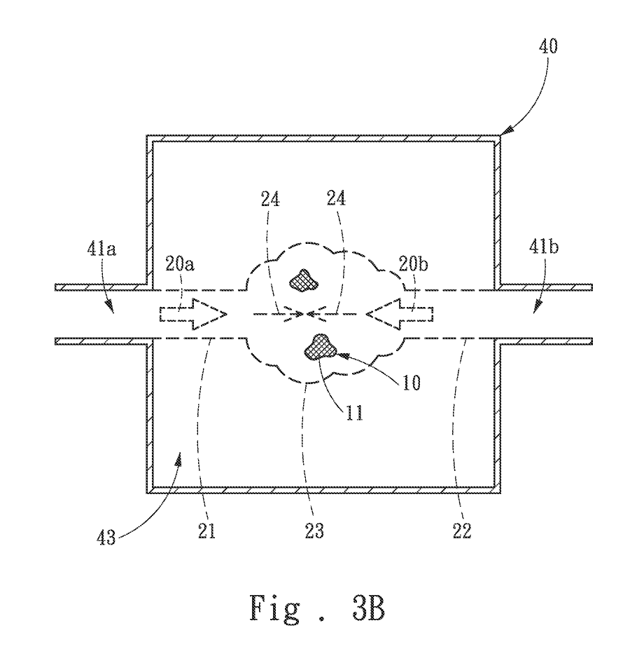

In step 3, a shear airflow 24 produced by the airflow interface 23 is applied to the graphite blocks 10. The shear airflow 24 has an energy sufficient for damanging the van der Waals force to disengage a part of the graphene layers 11. Referring to FIG. 3A and FIG. 3B, FIG. 3A shows a first schematic diagram of a shear airflow of the present invention. FIG. 3B shows a second schematic diagram of a shear airflow of the present invention. Associated details are given below. As shown in FIG. 3A, when flow directions of the first flow path 21 and the second flow path 22 are non-aligned, the shear airflow 24 produced by the airflow interface 23 is distributed at two opposite sides of the airflow interface 23 and is capable of pulling the graphite blocks 10. As shown in FIG. 3B, when the flow directions of the first flow path 21 and the second flow path 22 face each other, the shear airflow 24 produced by the airflow interface 23 directly faces a central part of the airflow interface 23 to impact upon the graphite blocks 10. In the present invention, the shear airflow 24 has a wind speed between 1 m/s and 200 m/s, and generates the energy greater than 0.1 KJ/mole. In one embodiment of the present invention, preferably, the energy is between 0.1 KJ/mole and 5 KJ/mole. As such, the shear airflow 24 damages the van der Waals force when taking effect on the graphite blocks 10 located in the chamber 43, such that a part of the graphene layers 11 bonded to one another by the van der Waals force become disengaged from the graphite blocks 10. Further, a part of the forward airflow 20a and the reverse airflow 20b leave the chamber 43 from the airflow exit 42.

In step 4, a plurality of pieces of graphene platelets 30 disengaged from the graphite blocks 10 are collected. The graphene platelets 30 include one or multiple of the graphene layers 11. In continuation of the description of step 3, in the embodiment, the airflow generating device 40 may further include a collecting portion 44. The collecting portion 44 is in communication with the chamber 43, so that the graphene layers 11 disengaged from the graphite blocks 10 are allowed to fall into the collecting portion 44 from the chamber 43 and be collected to accordingly obtain the graphene platelets 30 including one or multiple of the graphene layers 11. The graphene platelets 30 may include 1 to 3000000 layers of the graphene layers 11, and has a diameter between 5 nm and 1000 μm. It should be the above values are examples for explaining the present invention, and are not to be construed as limitations to the present invention.

In conclusion, in the present invention, the shear airflow produced by the forward airflow and the reverse airflow at the airflow interface is applied to the graphite blocks. The van der Waals force that forms a bonding between the graphene layers is damaged by the energy of shear airflow to disengage the graphene layers from the graphite blocks to form the graphene platelets in large amounts. Thus, the present invention provides a simple manufacturing process and further promotes mass production at a fast speed.

1. A method for manufacturing graphene platelets, comprising:
step 1: providing a plurality of graphite blocks, each of the graphite blocks comprising a plurality of stacked graphene layers, between every two graphene layers being a bonding formed by a van der Waals force;
step 2: placing the graphite block in a chamber, and introducing a forward airflow and a reverse airflow into the chamber, the forward airflow forming a first flow path in the chamber, the reverse airflow forming a second flow path in the chamber, an airflow interface forming between the first flow path and the second flow path;
step 3: applying a shear airflow produced by the airflow interface to the graphite block, the shear airflow having an kinetic energy sufficient for damaging the van der Waals force to disengage a part of the graphene layers; and
step 4: collecting a plurality of pieces of the graphene platelet, the graphene platelets comprising one or multiple of the graphene layers.

2. The method for manufacturing graphene platelets of claim 1, wherein in step 2, the graphite block is placed in the chamber of an airflow generating device, the airflow generating device comprising a first entrance for receiving the forward airflow and being in communication with the chamber, a second entrance for receiving the reverse airflow and being in communication with the chamber, and an airflow exit in communication with the chamber, the airflow interface applying the shear airflow to the graphite block in the chamber.

3. The method for manufacturing graphene platelets of claim 2, wherein in step 3, the airflow generating device further comprises a collecting portion, into which the disengaged platelets falls.

4. The method for manufacturing graphene platelets of claim 3, wherein in step 4, the collecting portion collects the graphene platelets.

5. The method for manufacturing graphene platelets of claim 1, wherein in step 2, the forward airflow is selected from a group consisted of air, dry air, nitrogen (N₂), argon (Ar), helium (He), hydrogen (H₂), oxygen (O₂) and ammonia (NH₃).

6. The method for manufacturing graphene platelets of claim 1, wherein in step 2, the reverse airflow is selected from a group consisted of air, dry air, nitrogen (N₂), argon (Ar), helium (He), hydrogen (H₂), oxygen (O₂) and ammonia (NH₃).

7. The method for manufacturing graphene platelets of claim 1, wherein in step 3, a airflow speed of the shear airflow is between 1 m/s and 200 m/s.

8. The method for manufacturing graphene platelets of claim 1, wherein in step 3, the kinetic energy is at least higher than 0.1 KJ/mole.

9. The method for manufacturing graphene platelets of claim 8, wherein the kinetic energy is between 0.1 KJ/mole and 5 KJ/mole.

10. The method for manufacturing graphene platelets of claim 1, wherein the graphene platelets has a diameter between 5 nm and 1000 μm.
